(19) United States
(12) Patent Application Publication
(10) Pub. No.: US 2019/0026537 A1
(43) Pub. Date: Jan. 24, 2019

(54) METHODS AND SYSTEM TO PREDICT HAND POSITIONS FOR MULTI-HAND GRASPS OF INDUSTRIAL OBJECTS

(71) Applicant: SIEMENS PRODUCT LIFECYCLE MANAGEMENT SOFTWARE INC., Plano, TX (US)

(72) Inventors: Erhan ARISOY, Princeton, NJ (US); Suraj Ravi MUSUVATHY, Princeton, NJ (US); Erva ULU, Pittsburgh, PA (US); Nurcan Gecer ULU, Pittsburgh, PA (US)

(73) Assignee: Siemens Product Lifecycle Management Software Inc., Plano, TX (US)

(21) Appl. No.: 16/070,206

(22) PCT Filed: Jan. 24, 2017
(86) PCT No.: PCT/US2017/014713

§ 371 Date: Jul. 13, 2018

Related U.S. Application Data
(60) Provisional application No. 62/286,706, filed on Jan. 25, 2016.

(51) Int. Cl. G06K 9/00; G06N 7/00; G06F 15/18; G06T 7/60

(52) U.S. Cl. CPC G06K 9/00201; G06T 7/60; G06F 15/18; G06N 7/005

(57) ABSTRACT

A computer-implemented method of predicting hand positions for multi-handed grasps of objects includes receiving a plurality of three-dimensional models and for each three-dimensional model, receiving user data comprising (i) user-provided grasping point pairs and (ii) labelling data indicating whether a particular grasping point pair is suitable or unsuitable for grasping. For each three-dimensional model, geometrical features related to object grasping are extracted based on the user data corresponding to the three-dimensional model. A machine learning model is trained to correlate the geometrical features with the labelling data associated with each corresponding grasping point pair and candidate grasping point pairs are determined for a new three-dimensional model. The machine learning model may then be used to select a subset of the plurality of candidate grasping point pairs as natural grasping points of the three-dimensional model.

### CROSS-REFERENCE TO RELATED APPLICATIONS

This application claims the benefit of U.S. Provisional Application Ser. No. 62/286,706 filed Jan. 25, 2016, which is incorporated herein by reference in its entirety.

### TECHNICAL FIELD

The present disclosure generally relates to systems, methods, and apparatuses related to a data-driven approach to predict hand positions for multi-hand grasps of industrial objects. The techniques described herein may be applied, for example, in industrial environment to provide users with suggested grasp positions for moving large objects.

### BACKGROUND

The ever rising demand for innovative products, more sustainable production, and increasingly competitive global markets require constant adaptation and improvement of manufacturing strategies. Launching faster, obtaining higher return on investment, and delivering quality products, especially in demanding economic times and considering regulatory factors necessitates optimal planning and usage of manufacturing production capacity. Digital simulation of production plants and factories are invaluable tools for this purpose. Commercial software systems such as Siemens PLM Software Tecnomatix provide powerful simulation functionality, and tools for visualizing and analyzing results of the simulations.

Key aspects of optimizing manufacturing facilities that involve human operators include optimizing work cell layouts and activities for improving human operator effectiveness, safety and ergonomics. Examples of operations that are typically configured and analyzed in a simulation include humans picking and moving objects from one place to another, assembling a product consisting of multiple components in a factory, and using hand tools to perform maintenance tasks. One of the challenges in configuring such a simulation is in specifying the locations of the grasp points on objects that human interact. The current approach relies on a manual process through which a user must specify the places where the human model should grasp each object. This is a tedious and time consuming process, and therefore a bottleneck in configuring large scale simulations. Therefore automated techniques for estimating natural grasp points are desirable.

### SUMMARY

Embodiments of the present invention address and overcome one or more of the above shortcomings and drawbacks, by providing methods, systems, and apparatuses related to a data-driven approach to predict hand positions for multi-hand grasps of industrial objects. More specifically, the techniques described herein employ a data driven approach for estimating natural looking grasp point locations on objects that human operators typically interact with in production facilities. These objects may include, for example, mechanical tools, parts and components specific to products being manufactured or maintained such as automotive parts, etc.

According to some embodiments, a computer-implemented method of predicting hand positions for multi-handed grasps of objects includes receiving a plurality of three-dimensional models and for each three-dimensional model, receiving user data comprising (i) user-provided grasping point pairs and (ii) labelling data indicating whether a particular grasping point pair is suitable or unsuitable for grasping. For each three-dimensional model, geometrical features related to object grasping are extracted based on the user data corresponding to the three-dimensional model. A machine learning model (e.g., a Bayesian network classifier) is trained to correlate the geometrical features with the labelling data associated with each corresponding grasping point pair and candidate grasping point pairs are determined for a new three-dimensional model. The machine learning model may then be used to select a subset of the plurality of candidate grasping point pairs as natural grasping points of the three-dimensional model. In some embodiments, the method further includes generating a visualization of the three-dimensional model showing the subset of candidate grasping point pairs with a line connecting points in each respective candidate grasping point pair.

Various geometrical features may be used in conjunction with the aforementioned method. For example, in one embodiment two distance values are calculated: a first distance value corresponding to distance between a first grasping point and a vertical plane passing through the center of mass of the three-dimensional model and a second distance value corresponding to distance between a second grasping point and the vertical plane passing through the center of mass of the three-dimensional model. A first geometrical feature may be calculated by summing the first distance value and the second distance value. A second geometrical feature may be calculated by summing the absolute value of the first distance value and absolute values of the second distance value.

In other embodiments, a vector connecting a first grasping point and a second grasping point on the three-dimensional model is calculated. Next, two surface normal are determined, corresponding to the first and second grasping points. Then, a third geometrical feature may be calculated by determining the arctangent of (i) the absolute value of the cross-product of the vector and the first surface normal and (ii) the dot product of the vector and the first surface normal. A fourth geometrical feature may be calculated by determining the arctangent of (i) the absolute value of a cross-product of the vector and the second surface normal and (ii) a dot product of the vector and the second surface normal. A fifth geometrical feature may be calculated by determining a dot product of the vector and a gravitational field vector. A sixth geometrical feature may be calculated by determining a dot product of the vector and a second vector representative of a frontal direction that a human is facing with respect to the three-dimensional model.

In some embodiments of the aforementioned method, the machine learning model selects the subset of the candidate grasping points by generating candidate grasping point pairs based on the candidate grasping points and generating features for each of the candidate grasping point pairs. The features are then used as input to the machine learning model to determine classification for each candidate grasping point pair indicating whether it is suitable or unsuitable for grasping. In one embodiment, the candidate grasping point pairs are generated by randomly combining the candidate grasping points.

According to another aspect of the present invention, a computer-implemented method of predicting hand positions for multi-handed grasps of objects includes receiving a three-dimensional model corresponding to a physical object and comprising one or more surfaces and uniformly sampling points on at least one surface of the three-dimensional model to yield a plurality of surface points. Next, grasping point pairs are created based on the plurality of surface points (e.g., by randomly combining surface points). Each grasping point pair comprises two surface points. For each of the plurality of grasping point pairs, a geometrical feature vector is calculated. Then, a machine learning model may be used to determine a grasping probability value for each grasping point pair indicating whether the physical object is graspable a locations corresponding to the grasping point pair. In some embodiments, the grasping point pairs are then ranked based on their respective grasping probability value and a subset of the grasping point pairs representing a predetermined number of highest ranking grasping point pairs is displayed.

According to other embodiments of the present invention, a system for predicting hand positions for multi-handed grasps of objects includes a database and a parallel computing platform comprising a plurality of processors. The database comprises a plurality of three-dimensional models and user data records for each three-dimensional model (i) one or more user-provided grasping point pairs on the three-dimensional model and (ii) labelling data indicating whether a particular grasping point pair is suitable or unsuitable for grasping. The parallel computing platform is configured to extract a plurality of geometrical features related to object grasping for each three-dimensional model in the database based on the user data record corresponding to the three-dimensional model. The parallel computing platform trains a machine learning model to correlate the geometrical features with the labelling data associated with each corresponding grasping point pair and determines candidate grasping point pairs for a new three-dimensional model. Then, a machine learning model may be used by the parallel computing platform to select candidate grasping point pairs as natural grasping points of the three-dimensional model.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 illustrates a decision support framework for estimating natural grip positions for a new 3D object, as it may be implemented in some embodiments of the present invention;

FIG. 2A shows an example of the interface for manually selecting graspable contact points, according to some embodiments;

FIG. 2B illustrates an second example of an interface that may be used in some embodiments;

FIG. 3 provides examples of geometries that may be used during phase 105, according to some embodiments;

FIG. 4 shows the utility of features f³ and f⁴ as applied to grasping a rectangular object;

FIG. 5 shows example feature set profiles calculated for two different configurations, according to some embodiments;

FIG. 6 illustrates a pipeline for grasping point estimation, according to some embodiments; and

FIG. 7 provides an example of a parallel processing memory architecture 700 that may be utilized to perform computations related to execution of the various workflows discussed herein, according to some embodiments of the present invention.

### DETAILED DESCRIPTION

The following disclosure describes the present invention according to several embodiments directed at methods, systems, and apparatuses related to a data-driven approach to predict hand positions for two-hand grasps of industrial objects. The wide spread use of 3D acquisition devices with high-performance processing tools has facilitated rapid generation of digital twin models for large production plants and factories for optimizing work cell layouts and improving human operator effectiveness, safety and ergonomics. Although recent advances in digital simulation tools have enabled users to analyze the workspace using virtual human and environment models, these tools are still highly dependent on user input to configure the simulation environment such as how humans are picking and moving different objects during manufacturing. As a step towards, alleviating user involvement in such analysis, we introduce a data-driven approach for estimating natural grasp point locations on objects that human interact with in industrial applications. As described in further detail below, the techniques described herein use a computer-aided design (CAD) model as input and outputs a list of candidate natural grasping point locations. We start with generation of a crowdsourced grasping database that consists of CAD models and corresponding grasping point locations that are labeled as natural or not. Next, we employ a Bayesian network classifier to learn a mapping between object geometry and natural grasping locations using a set of geometrical features. Then, for a novel object, we create a list of candidate grasping positions and select a subset of these possible locations as natural grasping contacts using our machine learning model.

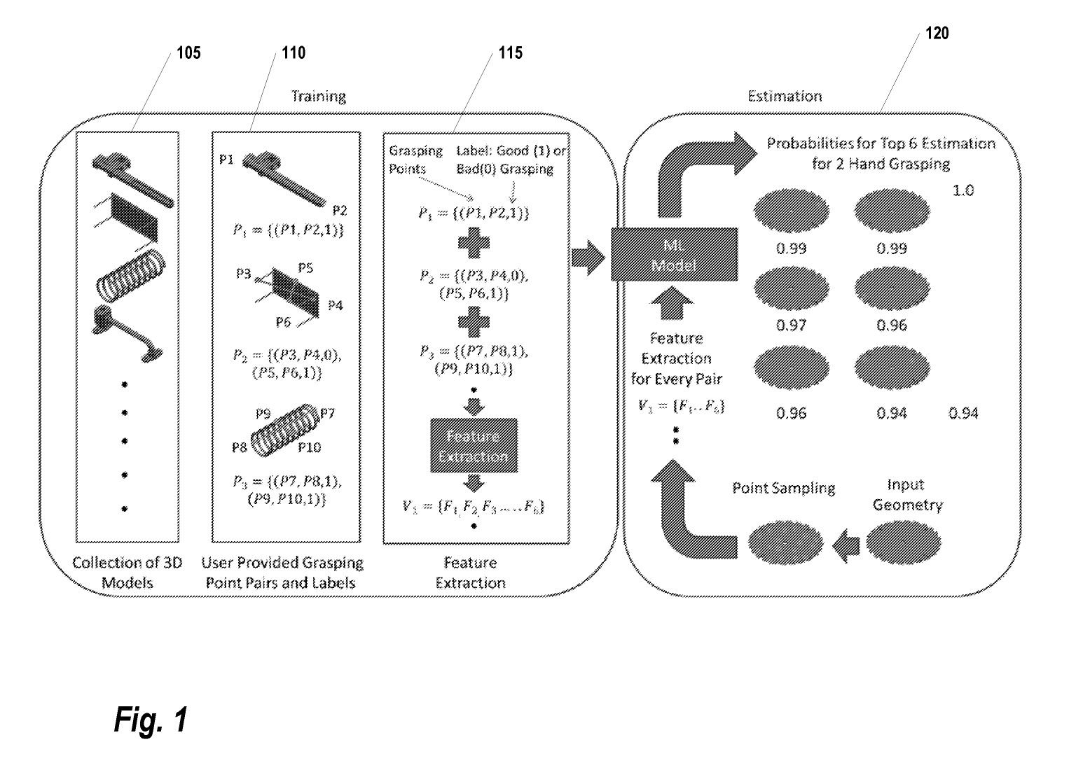

FIG. 1 illustrates a decision support framework for estimating natural grip positions for a new 3D object, as it may be implemented in some embodiments of the present invention. This framework take inspirations from the fact that humans are able to identify good grasping locations for novel objects, in a fraction of a second, based on their previous experiences with grasping different objects. To mimic this extraordinary capability, a learning-based algorithm utilizes a database of 3D models with corresponding crowdsourced natural grasp locations and identifies a set of candidate hand positions for two hand natural grasps of new objects.

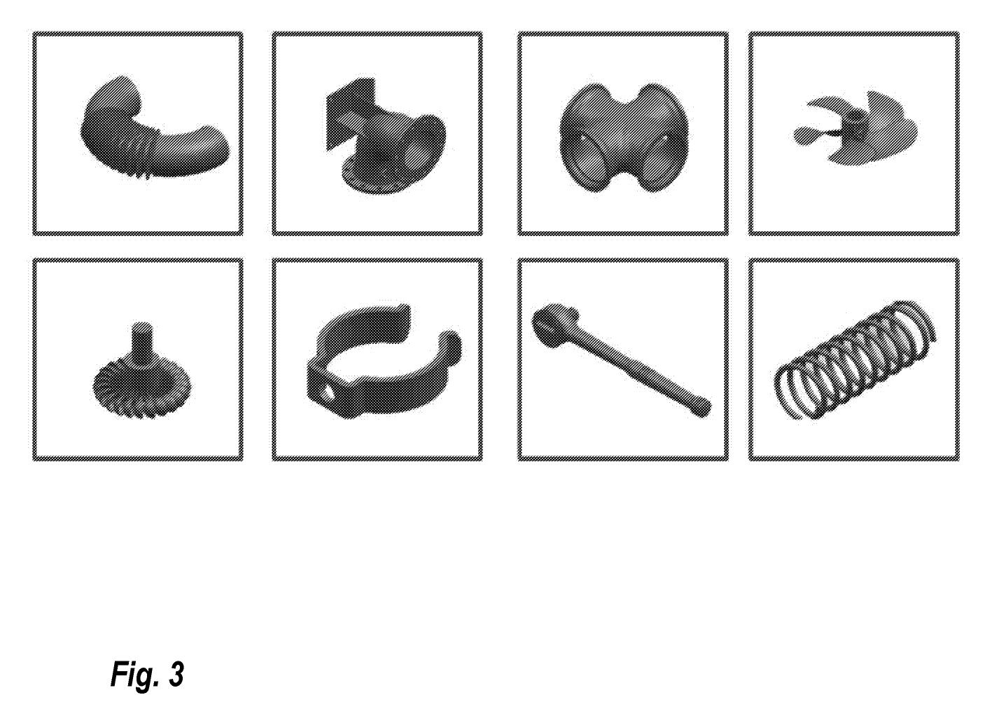

The natural grasping point estimation algorithm shown in FIG. 1 comprises 5 main phases. At phase 105, 3D models are collected. In general, any type of 3D model may be used including, without limitation CAD models. The collected models may include a generic library of objects, objects specific to a particular domain, and/or objects that meet some other characteristic. FIG. 3 provides an example of geometries that may be used during phase 105, according to some embodiments.

At phase 110, users provide pairs of grasping point locations on the 3D geometry that is randomly selected among the models in the database and displayed to the users. The users are asked to provide examples of both good and bad grasping point locations and these point locations and corresponding geometries are recorded. In some embodiments, the random draw from the database is determined by the current status of the distribution of the recorded both good and bad grasping point locations for every 3D model. For example, if the database has many both positive and negative grasping locations for a geometry A compared to geometry B, the random draw algorithm may lean toward selecting geometry B for grasp location data collection. The information included in the database for each object may vary in different embodiments of the present invention. For example, in one embodiment, each database record comprises (i) the name of the object file; (ii) a transformation matrix for the original object to its final location, orientation, and scale; (iii) manually selected gripping locations (right hand, left hand); (iv) surface normal at gripping locations (right hand, left hand); and (v) classification of the instance (“1” for graspable, “0” for not graspable). In other embodiments, other representations of the relevant data may be used. It should be noted that the list may be extended in some embodiments based on the availability of additional data. For example, the framework shown in FIG. 1 may be extended to large objects that require multiple people to grasp the object simultaneously. In this case, multiple pairs of grasp points (each pair corresponding to one of the people) may be used.

Continuing with reference to FIG. 1, at phase 115, geometrical features are selected and extracted for learning the relationship between objects' geometry and natural grasping point locations. As described in further detail below, these features mathematically encode the configuration of different grasping locations on 3D geometries. Next, at phase 120, a ML model is trained on the collected grasping database using these features. The key learning problem is extracting a mapping between the geometry of 3D objects and the corresponding natural grasping locations for these 3D objects by mathematically encoding how people lift 3D objects in their daily lives using the database discussed above. In some embodiments, to achieve this goal, a machine learning toolkit (e.g., the Waikato Environment for Knowledge Analysis or “WEKA” library) is utilized to experiment and study the performance of different machine learning models. The database may first be partitioned into a training set and a testing set. After splitting the database into training and testing components, experiments may be performed with several types of different classifiers (e.g. Naive Bayes Decision Trees, Random Forests, Multilayer Perceptron, etc.) to determine the best learning approach.

Also during phase 120, data-driven grasp point estimation is performed by sampling new input geometries and extracting relevant features. These features are then used as input into the trained model to identify the top positions of the object for grasping.

In some embodiments, one or more of following simplifications may be applied to the framework shown in FIG. 1. First, it may be assumed that the objects (a) will be lifted with both hands; (b) will be solid; and (c) will have uniform material distribution. Based on these assumptions, the center of mass is assumed to match the centroid of the input geometry. Secondly it may be assumed that the objects are light enough to be carried by human and the objects do not contain handles or thin edges where humans can grasp these objects using these handles. Third, hand/finger joint positions/orientations may be ignored and estimation may be limited to hand positions. A great analogy for this assumption is modeling the human workers as if they are wearing boxing gloves while lifting target objects.

In order to estimate natural grasping positions given a new object, inspiration may be taken from the fact that human conceptual knowledge can identify grasping regions for a new target object in a fraction of seconds based on his previous interactions with different objects. For instance, people may only need to see one example of a novel screw driver in order to estimate grasping boundaries of the new concept. Although recent studies for grasp location estimation focus on pure geometrical approaches, a goal of the framework described herein is to mimic human conceptual knowledge to learn the way people create a rich and flexible representation for the grasping problem based on their past interactions with different objects and geometries. To achieve this goal, a user interface where users can import 3D models and pick two candidate grasping locations on the imported 3D surface. This user interface may be implemented using programming languages (e.g., C++) and user interface technologies generally known in the art.

As noted above with reference to Phase 110 in FIG. 1, after picking candidate grasping locations, selected point pairs are labeled as good or bad grasping positions. In some embodiments, a software interface is used to populate a database of 3D models and grasping point pairs that are labeled as good or bad. In some embodiments, this labeling is performed manually using techniques such as crowdsourcing. In other embodiments, labeling may be performed automatically by observing how individuals interact with physical objects. For example, in one embodiment, image data or video data is analyzed to determine how individuals grasp objects.

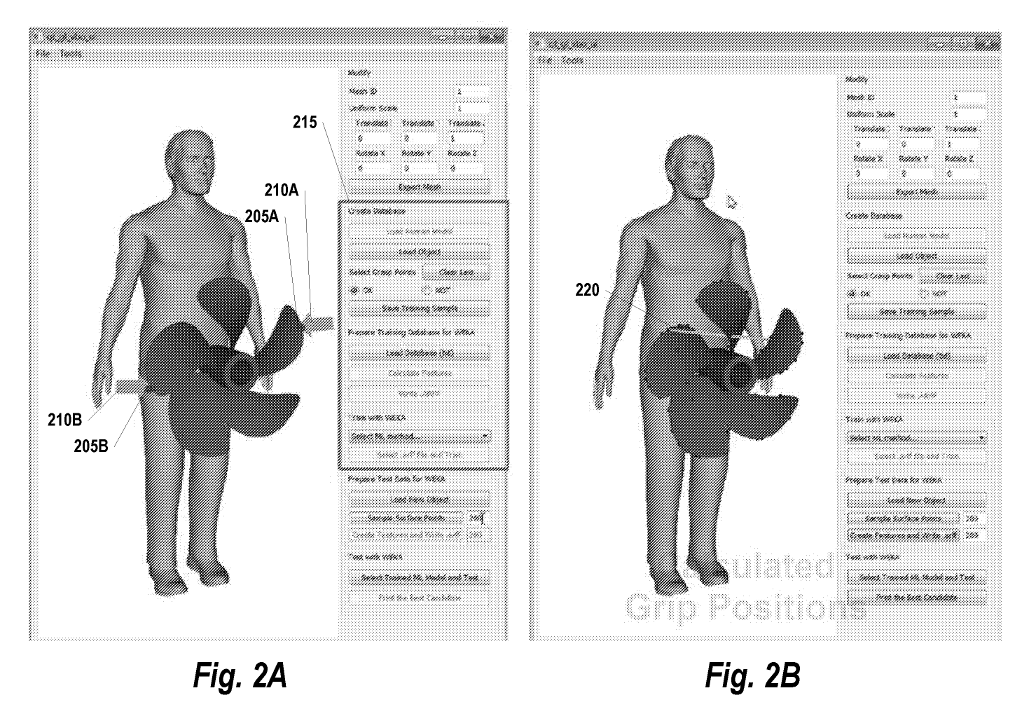

FIG. 2A shows an example of the interface for manually selecting graspable contact points, according to some embodiments. The user first selects graspable contact points 205A and 205B (pointed to by the arrows 210A and 210B). Then, the user interacts with a database generation menu (highlighted by boundary 215) to save the object model and the graspable object points as a training sample in the database. Once in the database, the object model and the graspable object points may be pre-processed, for example, to scale the geometry of the model or adjust its orientation. After pre-processing, different scaling transformations may be applied in some embodiments in order to populate the database with additional synthetic models.

FIG. 2B illustrates a second example of an interface that may be used in some embodiments. In this example, estimated grasp locations are connected by a gray line 220. It should be noted that the use of a gray line is only one example of a visualization device which can be used to highlight the connection between grasping point pairs. In other embodiments, different visualizations may be used (e.g., different colors, line thickness, line styles, etc.).

Geometrical features are used to capture the conceptual human knowledge that is encoded in the collected database of grasps. The goal is to find a mathematical representation that will allow one to determine whether a given grasp can be evaluated as viable or not. In particular, a feature set should capture the natural way of grasping an object; therefore formulations are based primarily on observations. The feature set should further contain the information about the stability and relative configurations of contact positions with respect to each other and the center of the object's mass. To calculate the center of mass of an object in the database, the center of mass is approximated by the geometrical centroid of the object. The centroid is calculated by computing the surface integral over a closed mesh surface. For each grasping configuration, the contact positions are denoted as p₁ and p₂. The surface normals at p₁ and p₂ are marked as n₁ and n₂ and the location of the center of mass is denoted as p_{CoM}. The vector connecting p₁ to p₂ is labeled as n_{c}. Additionally, the signed distance between every grasping point and the vertical plane passing through the center of the mass of the input geometry is labeled as d₁ and d₂. The following equations present the calculation of n_{c}, d₁ and d₂ values:

n_{c}=(p₁−p₂)/∥p₁−p₂∥

d₁=n_{c}·(p₁−p_{CoM})

d₂=n_{c}·(p₂−p_{CoM}) (1)

Various features may be used to represent the solution space for the two-hand grasping problem. The following paragraphs detail a subject of geometrical features that may be especially relevant.

Humans tend to lift objects using symmetrical grasping locations with respect to the vertical plane passing through the center of mass in order to minimize the difference between lifting forces applied by both hands. In an effort to measure humans' tolerance to mismatch in this, a first feature may be formulated as follows:

f¹=d₁+d₂ (2)

This feature also allows the algorithm learn and avoid generating unstable cases such as grasping an object from two points at one side of the center of mass.

Anatomical limitations allow humans to extend their arms only to a limited extent while carrying an object comfortably. Similarly, keeping two hands very close while lifting a large object may be uncomfortable for humans. In order to capture the comfortable range of distance between two grasp locations, a second feature may be formulated as follows:

f²=|d₁|+|d₂| (3)

In addition to the distance based features, f¹ and f², the angles formed between the surface normals and the line passing through the contact points may be used as third and fourth features:

f³=at an2(∥n_{c}×n₁∥,n_{c}·n₁)

f⁴=at an2(∥n_{c}×n₂∥, n_{c}·n₂) (4)

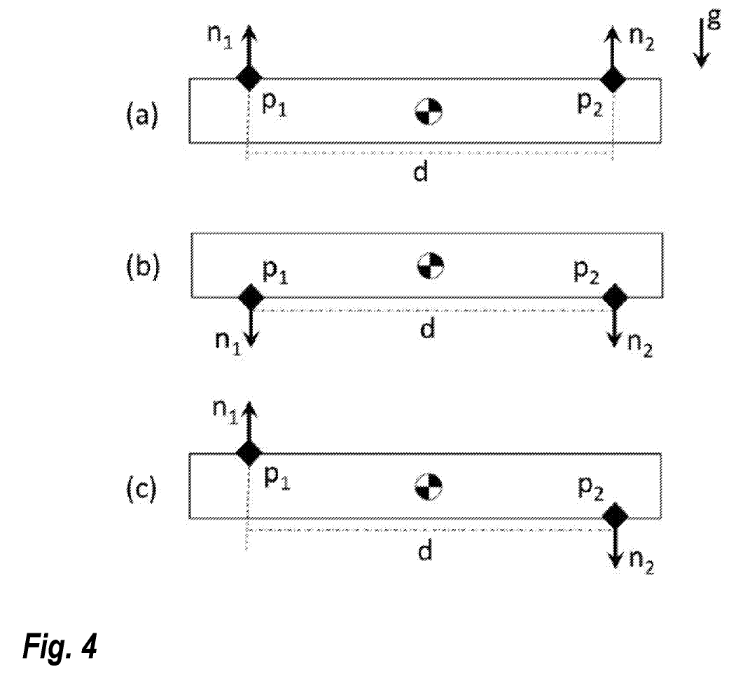

Note that this formulation is based on the assumption that p₁ and p₂ correspond to contact points for certain sides hands (e.g., p₁ is right and p₂ is left hand) and this should be consistent throughout the entire database. FIG. 4 shows the utility of features f³ and f⁴ as applied to grasping a rectangular object. Although all three examples in the figure look the same in terms of distance based features (f¹ and f²,), only (b) is a stable grasp point configuration to carry the rectangular object. Features f³ and f⁴. allow one to distinguish between these three situations.

The angle formed between the gravitational field vector and the line passing through the contact points may be used as fifth feature:

f⁵=g·n_{c} (5)

This feature captures the orientation of the grasping pairs mutually with respect to a global static reference. In Equation 5, g represents the gravitational field vector. In one embodiment, g is equal to [0,−1, 0]^{T}.

A sixth geometrical feature may be extracted for the learning problem:

f⁶=z·n_{c} (6)

where z represents frontal direction at which human is facing. In some embodiments, z is set equal to [0,0,1]^{T}.by fixing the global coordinate frame on human body. Together with f⁵, this feature allows the algorithm described herein to learn allowable orientation of human grasps with respect to a global static reference frame.

For every grasping point pairs i and j, a six dimensional feature vector may be generated where every component corresponds to one of the calculated features:

Fᵢⱼ=[fᵢⱼ¹, fᵢⱼ², fᵢⱼ³, fᵢⱼ⁴, fᵢⱼ⁵, fᵢⱼ⁶]^{T} (7)

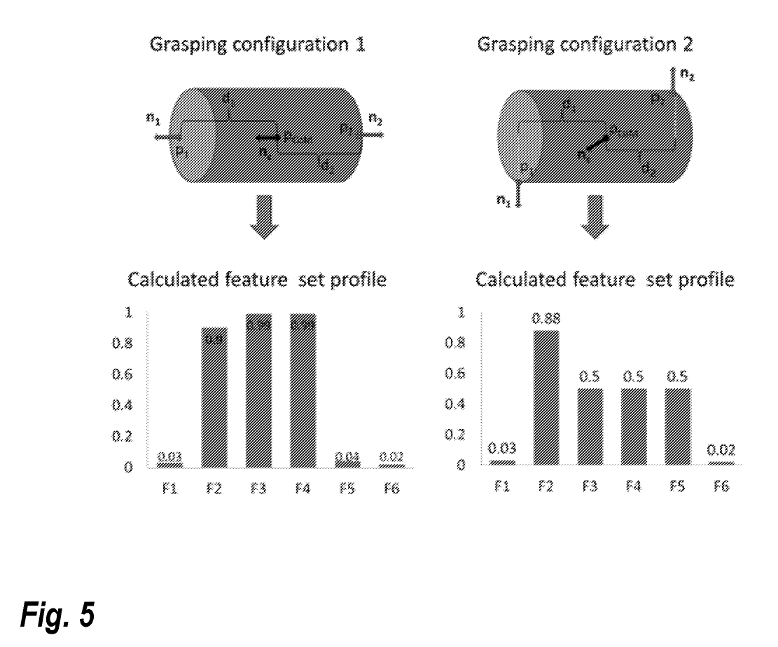

FIG. 5 shows example feature set profiles calculated for two different configurations, according to some embodiments. According to this figure, even if the target geometry to be lifted is the same for all four grasping cases, corresponding feature sets are unique for every case. The feature set profile demonstrates the capability of differentiating varying p₁ and p₂ configurations in the six dimensional feature space.

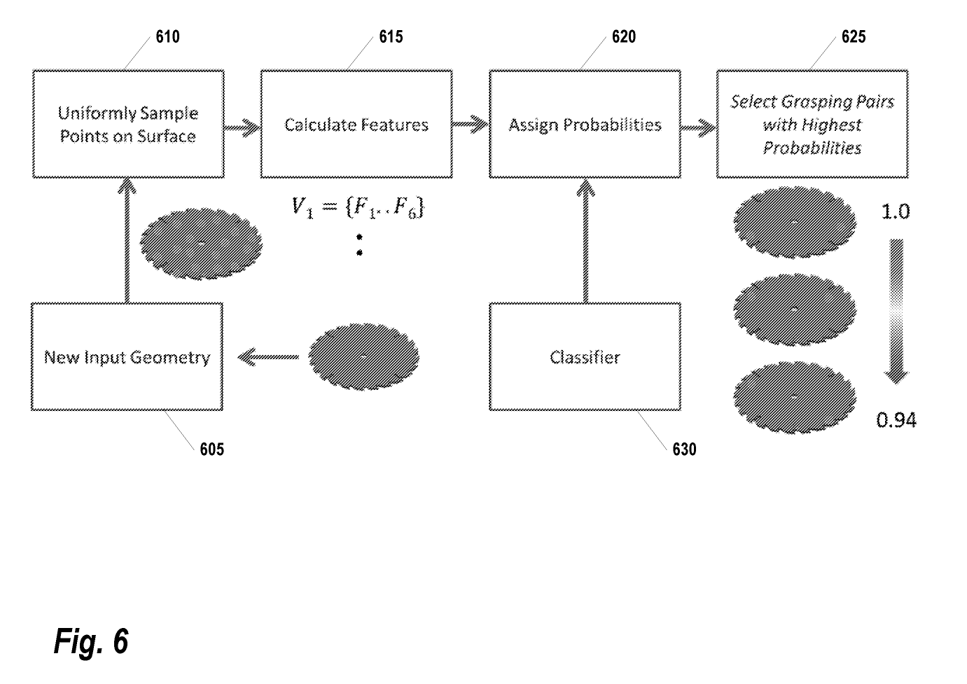

FIG. 6 illustrates a pipeline for grasping point estimation, according to some embodiments. First of all, at step 605, the user inputs the 3D geometry of the target object as a triangular representation into our interface for grasping point estimation. Secondly, at step 610, a fixed number of points are uniformly sampled on the 3D surface of the input geometry. The number of sampled points may be automatically determined (e.g., based on object geometry) or, alternative, this number may be specified by a user. For example, in one embodiment, the number of sampled points is controlled by a parameter adjusted by the user. These sample points serve as an initial candidate set for the estimation problem. Next, pairs of points (corresponding to two-hand grasping) are randomly selected among these uniformly sampled points. Next, at step 615, feature vectors are calculated for every pair as described in previous section. Then, at step 620, a Classifier 630 is applied each candidate pair using their respective feature vector and probabilities are assigned to the pair based on the classification results. Once the probability values are determined, at step 625 the candidate grasping pairs are automatically ranked to allow identification of top grasping pairs. In one embodiment, for visualization purposes, lines may be automatically generated that connect grasping points for every down-selected pair.

The techniques described herein provide a data-driven approach for estimating natural grasp point locations on objects that human interact with in industrial applications. The mapping between the feature vectors and 3D object geometries are dictated by grasping locations crowdsourcing. Hence, the disclosed techniques can accommodate new geometries as well as new grasping location preferences. It should be noted that various enhancements and other modifications can be made the techniques described herein based on the available data or features of the object. For example, a preprocessing algorithm can be implemented to check if the object contains such handles before running the data-driven estimation tool. Additionally, integration of data-driven approaches with physics-based models for grasping location estimation may be used to incorporate material properties.

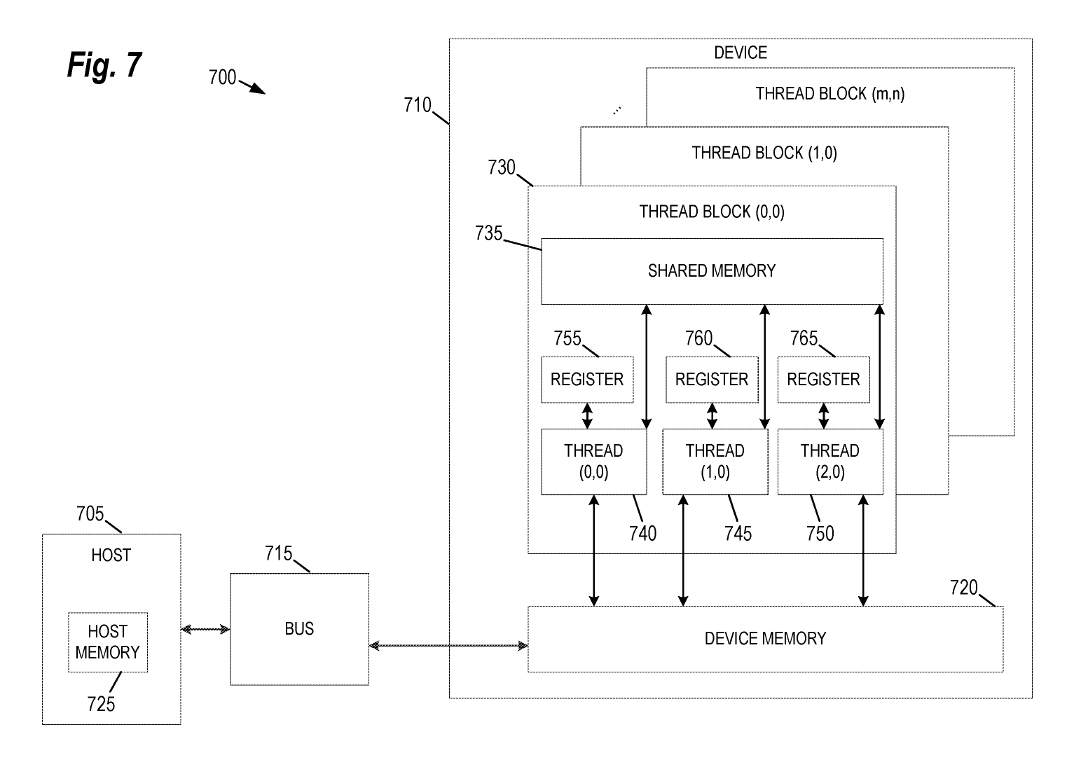

FIG. 7 provides an example of a parallel processing memory architecture 700 that may be utilized to perform computations related to execution of the various workflows discussed herein, according to some embodiments of the present invention. This architecture 700 may be used in embodiments of the present invention where NVIDIA™ CUDA (or a similar parallel computing platform) is used. The architecture includes a host computing unit (“host”) 705 and a graphics processing unit (GPU) device (“device”) 710 connected via a bus 715 (e.g., a PCIe bus). The host 705 includes the central processing unit, or “CPU” (not shown in FIG. 7), and host memory 725 accessible to the CPU. The device 710 includes the graphics processing unit (GPU) and its associated memory 720, referred to herein as device memory. The device memory 720 may include various types of memory, each optimized for different memory usages. For example, in some embodiments, the device memory includes global memory, constant memory, and texture memory.

Parallel portions of frameworks and pipelines discussed herein may be executed on the architecture 700 as “device kernels” or simply “kernels.” A kernel comprises parameterized code configured to perform a particular function. The parallel computing platform is configured to execute these kernels in an optimal manner across the architecture 700 based on parameters, settings, and other selections provided by the user. Additionally, in some embodiments, the parallel computing platform may include additional functionality to allow for automatic processing of kernels in an optimal manner with minimal input provided by the user.

The processing required for each kernel is performed by grid of thread blocks (described in greater detail below). Using concurrent kernel execution, streams, and synchronization with lightweight events, the architecture 700 of FIG. 7 (or similar architectures) may be used to parallelize modification or analysis of the digital twin graph. For example, in some embodiments, the operations of the ML model may be partitioned such that multiple kernels analyze different grasp positions and/or feature vectors simultaneously.

The device 710 includes one or more thread blocks 730 which represent the computation unit of the device 710. The term thread block refers to a group of threads that can cooperate via shared memory and synchronize their execution to coordinate memory accesses. For example, in FIG. 7, threads 740, 745 and 750 operate in thread block 730 and access shared memory 735. Depending on the parallel computing platform used, thread blocks may be organized in a grid structure. A computation or series of computations may then be mapped onto this grid. For example, in embodiments utilizing CUDA, computations may be mapped on one-, two-, or three-dimensional grids. Each grid contains multiple thread blocks, and each thread block contains multiple threads. For example, in FIG. 7, the thread blocks 730 are organized in a two dimensional grid structure with m+1 rows and n+1 columns. Generally, threads in different thread blocks of the same grid cannot communicate or synchronize with each other. However, thread blocks in the same grid can run on the same multiprocessor within the GPU at the same time. The number of threads in each thread block may be limited by hardware or software constraints.

Continuing with reference to FIG. 7, registers 755, 760, and 765 represent the fast memory available to thread block 730. Each register is only accessible by a single thread. Thus, for example, register 755 may only be accessed by thread 740. Conversely, shared memory is allocated per thread block, so all threads in the block have access to the same shared memory. Thus, shared memory 735 is designed to be accessed, in parallel, by each thread 740, 745, and 750 in thread block 730. Threads can access data in shared memory 735 loaded from device memory 720 by other threads within the same thread block (e.g., thread block 730). The device memory 720 is accessed by all blocks of the grid and may be implemented using, for example, Dynamic Random-Access Memory (DRAM).

Each thread can have one or more levels of memory access. For example, in the architecture 700 of FIG. 7, each thread may have three levels of memory access. First, each thread 740, 745, 750, can read and write to its corresponding registers 755, 760, and 765. Registers provide the fastest memory access to threads because there are no synchronization issues and the register is generally located close to a multiprocessor executing the thread. Second, each thread 740, 745, 750 in thread block 730, may read and write data to the shared memory 735 corresponding to that block 730. Generally, the time required for a thread to access shared memory exceeds that of register access due to the need to synchronize access among all the threads in the thread block. However, like the registers in the thread block, the shared memory is typically located close to the multiprocessor executing the threads. The third level of memory access allows all threads on the device 710 to read and/or write to the device memory. Device memory requires the longest time to access because access must be synchronized across the thread blocks operating on the device. Thus, in some embodiments, the processing of each pair of grasp points and/or feature vector is coded such that it primarily utilizes registers and shared memory. Then, use of device memory may be limited to movement of data in and out of a thread block.

The embodiments of the present disclosure may be implemented with any combination of hardware and software. For example, aside from parallel processing architecture presented in FIG. 7, standard computing platforms (e.g., servers, desktop computer, etc.) may be specially configured to perform the techniques discussed herein. In addition, the embodiments of the present disclosure may be included in an article of manufacture (e.g., one or more computer program products) having, for example, computer-readable, non-transitory media. The media may have embodied therein computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

1. A computer-implemented method of predicting hand positions for multi-handed grasps of objects, the method comprising:
receiving a plurality of three-dimensional models;
for each three-dimensional model, receiving user data comprising (i) one or more user-provided grasping point pairs and (ii) labelling data indicating whether a particular grasping point pair is suitable or unsuitable for grasping;
for each three-dimensional model, extracting a plurality of geometrical features related to object grasping based on the user data corresponding to the three-dimensional model; and
training a machine learning model to correlate the plurality of geometrical features with the labelling data associated with each corresponding grasping point pair;
determining a plurality of candidate grasping point pairs for a new three-dimensional model; and
using the machine learning model to select a subset of the plurality of candidate grasping point pairs as natural grasping points of the three-dimensional model.

2. The method of claim 1, wherein extracting the plurality of geometrical features related to object grasping based on the user data corresponding to the three-dimensional model comprises:
calculating a first distance value corresponding to distance between a first grasping point and a vertical plane passing through the center of mass of the three-dimensional model;
calculating a second distance value corresponding to distance between a second grasping point and the vertical plane passing through the center of mass of the three-dimensional model;
calculating a first geometrical feature included in the plurality of geometrical features by summing the first distance value and the second distance value.

3. The method of claim 2, wherein extracting the plurality of geometrical features related to object grasping based on the user data corresponding to the three-dimensional model further comprises:
calculating a second geometrical feature included in the plurality of geometrical features by summing the absolute value of the first distance value and absolute values of the second distance value.

4. The method of claim 1, wherein extracting the plurality of geometrical features related to object grasping based on the user data corresponding to the three-dimensional model further comprises:
calculating a vector connecting a first grasping point and a second grasping point on the three-dimensional model;
determining a first surface normal on the three-dimensional model at the first grasping point;
determining a second surface normal on the three-dimensional model at the second grasping point;
calculating a third geometrical feature included in the plurality of geometrical features by determining the arctangent of (i) the absolute value of the cross-product of the vector and the first surface normal and (ii) the dot product of the vector and the first surface normal; and
calculating a fourth geometrical feature included in the plurality of geometrical features by determining the arctangent of (i) the absolute value of a cross-product of the vector and the second surface normal and (ii) a dot product of the vector and the second surface normal.

5. The method of claim 1, wherein extracting the plurality of geometrical features related to object grasping based on the user data corresponding to the three-dimensional model further comprises:
calculating a vector connecting a first grasping point and a second grasping point on the three-dimensional model; and
calculating a geometrical feature included in the plurality of geometrical features by determining a dot product of the vector and a gravitational field vector.

6. The method of claim 1, wherein extracting the plurality of geometrical features related to object grasping based on the user data corresponding to the three-dimensional model further comprises:
calculating a vector connecting a first grasping point and a second grasping point on the three-dimensional model; and
calculating a geometrical feature included in the plurality of geometrical features by determining a dot product of the vector and a second vector representative of a frontal direction that a human is facing with respect to the three-dimensional model.

7. The method of claim 1, wherein the machine learning model is a Bayesian network classifier.

8. The method of claim 1, wherein using the machine learning model to select the subset of the plurality of candidate grasping points as natural grasping points of the three-dimensional model comprises:
generating a plurality of candidate grasping point pairs based on the plurality of candidate grasping points;
generating features for each of the plurality of candidate grasping point pairs;
using the features as input to the machine learning model, determining a classification for each candidate grasping point pair indicating whether it is suitable or unsuitable for grasping.

9. The method of claim 8, wherein the plurality of candidate grasping point pairs are generated by randomly combining the plurality of candidate grasping points.

10. The method of claim 1, further comprising:
generating a visualization of the three-dimensional model showing the subset of the plurality of candidate grasping point pairs with a line connecting points in each respective candidate grasping point pair.

11. A computer-implemented method of predicting hand positions for multi-handed grasps of objects, the method comprising:
receiving a three-dimensional model corresponding to a physical object and comprising one or more surfaces;
uniformly sampling points on at least one surface of the three-dimensional model to yield a plurality of surface points;
creating a plurality of grasping point pairs based on the plurality of surface points, wherein each grasping point pair comprises two surface points;
for each of the plurality of grasping point pairs, calculating a geometrical feature vector; and
using a machine learning model to determine a grasping probability value for each grasping point pair indicating whether the physical object is graspable a locations corresponding to the grasping point pair.

12. The method of claim 11, further comprising:
ranking the plurality of grasping point pairs based on their respective grasping probability value; and
displaying a subset of the plurality of grasping point pairs representing a predetermined number of highest ranking grasping point pairs.

13. The method of claim 11, wherein plurality of surface points comprises a user-selected number of points.

14. The method of claim 11, wherein the plurality of grasping point pairs is created by randomly combining surface points.

15. The method of claim 11, wherein the geometrical feature vector comprises a first geometrical feature calculated for each grasping point pair by:
calculating a first distance value corresponding to distance between a first point included in the grasping point pair and a vertical plane passing through the center of mass of the three-dimensional model;
calculating a second distance value corresponding to distance between a second point included in the grasping point pair and the vertical plane passing through the center of mass of the three-dimensional model;
calculating the first geometrical feature by summing the first distance value and the second distance value.

16. The method of claim 15, wherein the geometrical feature vector comprises a second geometrical feature calculated for each grasping point pair by:
calculating the second geometrical feature by summing the absolute value of the first distance value and absolute values of the second distance value.

17. The method of claim 16, wherein the geometrical feature vector comprises a third geometrical feature and a fourth geometrical feature calculated for each grasping point pair by
calculating a point-connecting vector connecting the first point included in the grasping point pair and the second point included in the grasping point pair on at least one surface of the physical object;
determining a first surface normal on the three-dimensional model at the first point;
determining a second surface normal on the three-dimensional model at the second point;
calculating the third geometrical feature by determining the arctangent of (i) the absolute value of the cross-product of the point-connecting vector and the first surface normal and (ii) the dot product of the point-connecting vector and the first surface normal; and
calculating the fourth geometrical feature by determining the arctangent of (i) the absolute value of a cross-product of the point-connecting vector and the second surface normal and (ii) a dot product of the point-connecting vector and the second surface normal.

18. The method of claim 17, wherein the geometrical feature vector comprises a fifth geometrical feature calculated for each grasping point pair by
calculating the fifth geometrical feature included by determining a dot product of the point-connecting vector and a gravitational field vector.

19. The method of claim 18, wherein the geometrical feature vector comprises a sixth geometrical feature calculated for each grasping point pair by
calculating the sixth geometrical feature by determining a dot product of the point-connecting vector and a second vector representative of a frontal direction that a human is facing with respect to the three-dimensional model.

20. A system for predicting hand positions for multi-handed grasps of objects:
a database comprising a plurality of three-dimensional models and user data records for each three-dimensional model (i) one or more user-provided grasping point pairs on the three-dimensional model and (ii) labelling data indicating whether a particular grasping point pair is suitable or unsuitable for grasping,
a parallel computing platform comprising a plurality of processors configured to:
for each three-dimensional model in the database, extract a plurality of geometrical features related to object grasping based on the user data record corresponding to the three-dimensional model, and
train a machine learning model to correlate the plurality of geometrical features with the labelling data associated with each corresponding grasping point pair,
determine a plurality of candidate grasping point pairs for a new three-dimensional model, and
use the machine learning model to select one or more candidate grasping point pairs as natural grasping points of the three-dimensional model.
